(19) United States
(12) Patent Application Publication
(10) Pub. No.: US 2012/0263640 A1
(43) Pub. Date: Oct. 18, 2012

(54) CYCLONE REACTOR AND METHOD FOR PRODUCING USABLE BY-PRODUCTS USING CYCLONE REACTOR

(75) Inventors: William Latta, Mooresville, NC (US); Scott Vierstra, Canal Winchester, OH (US); Matthew Targett, Shanghai (CN); Volker Michele, Koeln (DE); Rainer Bellinghausen, Odenthal (DE); Leslaw Mleczko, Dormagen (DE); Heinrich Morhenn, Koeln (DE); Oliver Schlueter, Leverkusen (DE)

(73) Assignee: LP Amina LLC

(21) Appl. No.: 13/400,528

(22) Filed: Feb. 20, 2012

Related U.S. Application Data
(60) Provisional application No. 61/444,944, filed on Feb. 21, 2011.

(51) Int. Cl. C01B 31/32; B01J 19/00

(52) U.S. Cl. 423/442; 422/187

(57) ABSTRACT

A cyclone reactor for producing a usable by-product as part of a recoverable slag layer, the reactor comprising a housing having an outer wall that defines a combustion chamber; an inlet configured to introduce a reactant into the reactor; a burner configured to combust the reactant in a flame zone near a central axis of the chamber; and an outlet configured to provide for the removal of the usable by-product from the housing; wherein the reactor is configured to combust a first portion of the reactant in an exothermic reaction in the flame zone; and wherein the reactor is configured to convert a second portion of the reactant in an endothermic reaction near the outer wall to produce the by-product as part of the slag layer.

### CROSS-REFERENCE TO RELATED PATENT APPLICATIONS

This application claims the benefit of and priority to U.S. Provisional Patent Application No. 61/444,944, which was filed on Feb. 21, 2011, the entire disclosure of which is incorporated herein by reference.

### BACKGROUND

The present application relates generally to the production of chemicals or materials using reactors that are otherwise configured to generate heat and electric power. More specifically, this application relates to an improved cyclone reactor for use in the generation of heat as well as for producing usable by-products that may be used in a variety of applications, such as in the production of calcium carbide (CaC₂) or other chemicals.

CaC₂ is a basic chemical that has utility in the production of other useful compounds such as acetylene (C₂H₂), which is commonly used in industrial organic chemistry for producing other compounds such as vinyl chloride or polyvinyl chloride. For example, CaC₂ may react with water to form acetylene according to the following formula:

CaC₂+2(H₂O)→C₂H₂+Ca(OH)₂

There are a number of different ways to produce CaC₂. For example, CaC₂ may be produced by heating a mixture of lime (e.g., calcium oxide or CaO) and carbon. CaC₂ may also be generated in an electric-arc furnace from the reaction of coke and calcium oxide when heated to a temperature ranging from 1600-2100° C. with carbon monoxide as another by-product, as expressed by the following reaction:

CaO+3C→CaC₂+CO

CaC₂ may also be produced by the direct reaction of coke with calcium oxide and oxygen, with carbon monoxide being produced as a by-product. This reaction is illustrated chemically by the following formula:

$$( 3 + n ) C + CaO + \frac{n}{2} {O}_{2} \to {CaC}_{2} + ( n + 1 ) CO$$

It may be desirable to investigate new methods for the production of CaC₂, especially in locations where oil reserves are limited and coal resources are plentiful. Methods of producing CaC₂, such as using electric arc furnaces, have poor energy efficiency and may also produce potentially detrimental environmental effects. It would be advantageous, for example, to produce CaC₂ or other carbon-based chemicals using a more efficient and more environmentally friendly method that relies on existing coal reserves. Especially advantageous would be a process where less expensive relative low-quality coal (i.e. coal with a low specific heat value) could be employed as a reactant.

### SUMMARY

One embodiment of the present application relates to a cyclone reactor for producing a usable by-product as part of a recoverable slag layer. The reactor may comprise a housing having an outer wall that defines a combustion chamber, an inlet configured to introduce a reactant into the reactor, a burner configured to combust the reactant in a flame zone near a central axis of the chamber, and an outlet configured to provide for the removal of the usable by-product from the housing. The reactor is configured to combust a first portion of the reactant in an exothermic reaction in the flame zone, and the reactor is configured to convert a second portion of the reactant in an endothermic reaction near the outer wall to produce the by-product as part of the slag layer.

Another embodiment of the present application relates to a method for producing a usable by-product in a cyclone reactor. The method may comprise introducing a reactant into a housing of the reactor through an inlet, using a burner to combust a first portion of the reactant in an exothermic reaction provided in a flame zone near a center of the housing, consuming a second portion of the reactant in an endothermic reaction near an outer wall of the housing to produce the by-product as part of a slag layer; and removing the slag layer including the by-product through an outlet in the housing. The endothermic reaction may take place at a temperature of at least 1600° C.

### BRIEF DESCRIPTION OF THE DRAWINGS

FIG. 1 is a schematic diagram of a system that includes a reactor according to an exemplary embodiment.

FIG. 2 is a schematic diagram of a system having a reactor according to another exemplary embodiment.

FIG. 3 is a cross-sectional view taken through the reactor of the system of FIG. 2 along line 3-3.

FIG. 4 is a side-view of the system of FIG. 2.

FIG. 5 is a perspective view of an exemplary embodiment of a reactor for use in the system according to an exemplary embodiment.

FIG. 6 is a side view of the reactor shown in FIG. 5.

FIG. 7 is a cross-sectional view of an exemplary embodiment of a reactor such as that shown in FIG. 5.

FIG. 8 is a partial cross-sectional view of a wall of the reactor shown in FIG. 7.

FIG. 9 is a schematic diagram illustrating the flow of the various layers of slag material along the wall of the reactor at a first location near the inlet end.

FIG. 10 is a schematic diagram illustrating the flow of the various layers of slag material along the wall of the reactor at a second location near the outlet end.

FIG. 11 is a side view of another exemplary embodiment of a reactor.

FIG. 12 is a chart illustrating the results of a computational fluid dynamic computer model evaluating an exemplary computer modeled embodiment of a reactor.

FIG. 13 is a chart illustrating the results of a computer predictive model evaluating the conversion of CaO to CaC₂ in the slag layer over the length of the computer modeled reactor.

### DETAILED DESCRIPTION

According to an exemplary embodiment, an improved and modified reactor (e.g., a cyclone burner or reactor) may be used for producing chemicals or materials, such as carbon-based chemicals, including, but not limited to calcium carbide (CaC₂), lithium carbide (Li₂C₂), sodium carbide (Na₂C₂), potassium carbide (K₂C₂), magnesium carbide (Mg₂C₃ or MgC₂). The improved reactor may advantageously allow for the production of such chemicals or materials using modified versions of existing technology using readily-available raw materials to produce chemicals for broad applicability.

Conventional cyclone burners are commonly used in coal-fired electric power plants, where coal having low ash melt temperatures is combusted for the generation of heat and electric power. Such cyclone burners, however, are typically operated at temperatures of between approximately 1200° C. and 1600° C. In contrast, to achieve the carbothermic reduction of calcium oxide (CaO) to CaC₂ that takes place at temperatures above 1600° C., hot gas and flame temperatures of 1600-2500° C. are necessary, which makes conventional cyclone burners used in coal-fired power plants particularly unsuitable.

According to an exemplary embodiment, a partial oxidation scheme is used to produce the chemicals, such that the reactants (e.g., lime and coal) are introduced into the system as solids and conveyed into the reactor using one or more inlets at suitable placements and inlet conditions. The reactor may be configured to operate in a gas staging mode of operation, where a first portion of the reactant (e.g., carbon) is combusted, such as with additionally introduced oxygen (or air), in an exothermic reaction to produce carbon monoxide and carbon dioxide (inducing the high reaction temperatures). A second portion (e.g., the remaining portion) of the reactant (e.g., carbon) then is consumed or converted in an endothermic reaction with the CaO to produce CaC₂ and CO, receiving the necessary energy input, such as through radiative heat transfer, from the combustion of the first portion of the reactant. The two reactions (e.g., exothermic, endothermic) in the reactor may occur substantially simultaneously or may occur independently with respect to time, and may take place in two different regions or locations in the reactor. The former exothermic reaction that induces the high reaction temperatures may take place in the center of the reactor near a central longitudinal axis of the reactor, such as in the flame zone region, within an oxidizing atmosphere. The latter endothermic reaction that produces a usable by-product (e.g., CaC₂) from CaO may occur in an at least partially liquid (or molten) slag phase, such that the slag forms a layer provided along the inside surface of the wall of the reactor in a reducing atmosphere. The liquid slag layer including the CaC₂ may then be recovered from the reactor to be subsequently used, for example, in the production of acetylene or for any other desired use.

According to an exemplary embodiment, an improved cyclone burner allows for the production of usable by-products as well as heat and electric power. Such an improved cyclone burner differs in several respects from conventional cyclone burners currently used. First, the reactor is configured to operate in a gas staging mode of operation, in which there are two separated gas zones within the reactor during operation. The first gas zone is a combustion or flame zone, which may be located substantially along the reactor axis where oxidizing conditions exist to fully (or substantially) combust a first portion of reactant (e.g., carbon) to form carbon-dioxide (CO₂) to make full use of the coal heat content to achieve high temperatures in this zone. The second gas zone occurs away from the first zone, such as close to the outer wall of the reactor, and is a reducing zone that enables the formation of calcium carbide (CaC₂) as part of a slag layer. The heat transfer from the first zone (i.e., the combustion zone) to the wall slag layer mainly occurs through radiant heat transfer, providing the high temperatures that facilitate the consumption of a second portion of the reactant (e.g., carbon) and the endothermic reaction that produces the by-product (e.g., CaC₂). It is preferred to minimize the mixing between the two gas zones to ensure stable gas layering (e.g., stratified flow). Accordingly, the mixing between the two gas zones may be controlled (e.g., reduced, minimized), for example, by tailoring the swirl and axial gas flow characteristics (e.g., velocities) within the reactor.

Second, the aspect ratio (i.e., the ratio of the length to the diameter) of the reactor is larger than in conventional cyclone burners to provide a longer centerline flame zone to allow for enough residence time of the reactants (e.g., CaO, C) to achieve the high wall temperatures and to complete the reaction to form the usable by-product, such as CaC₂.

Third, a flue gas recycle stream having preferably a CO-rich fraction may be introduced into the reactor, such as through an inlet, to support the reducing reaction conditions at the reactor wall in order to promote the carbide formation reaction.

Fourth, the pulverized coal burner configured within the reactor (e.g., along the reactor axis) may be optimized to allow more efficient mixing of the fuel, such as C or CaO if the reactants for the carbide reaction are not fed separately, and oxygen (and/or air) to facilitate faster heat release and a higher flame temperature to provide, such as to provide a stoichiometric ratio of the centerline flame zone as close to one (1) as possible. For example, the particle diameter of the pulverized coal may be reduced prior to being fed into the reactor. Smaller particle size of the coal may prolong suspension of the particles in the gas phase, which may provide for more efficient particle deposition downstream in the reactor.

In addition to the foregoing, the inventors have also found it advantageous to use smaller sized particles of reactants in the reactors disclosed herein compared to the particles used with conventional cyclone burners. The use of the smaller sized particles of reactants for the burner helps facilitate faster heat release to achieve the high wall temperatures required to produce the usable by-product.

Alternatively, the co-feeding of the reactants and oil into the burner of the reactor, such as being fed along the reactor axis or flame zone, may be utilized to facilitate the formation of the by-products. Another alternative is to use oil alone as the reactant input into the reactor. Small droplets of oil, such as oil droplets having diameters less than 100 μm, may be produced and fed into the flame zone of the burner to fuel the reaction. Small oil droplets may easily be produced using standard atomizing nozzles, as opposed to producing coal particles of that size which may involve energy-intensive comminution processes. Relative smaller droplet or particle size results in faster heat release, which in turn results in more efficient heat transfer to the wall, thereby creating the higher wall temperatures that are essential for the carbide generation reaction to proceed. Since gas residence time and therefore heat transfer efficiency may be especially critical with small-scale (or pilot installations) of the process, the oil co-firing may be especially advantageous therein, while conversely, in large-scale applications of the technology, oil co-firing may not be as advantageous.

Additionally, prior to being fed into the reactor, the coal may be processed to reduce the moisture content in the coal, such as through a coal-drying process, to increase the effective heat content of the coal. As another alternative, a higher quality (higher heat content) coal may be used.

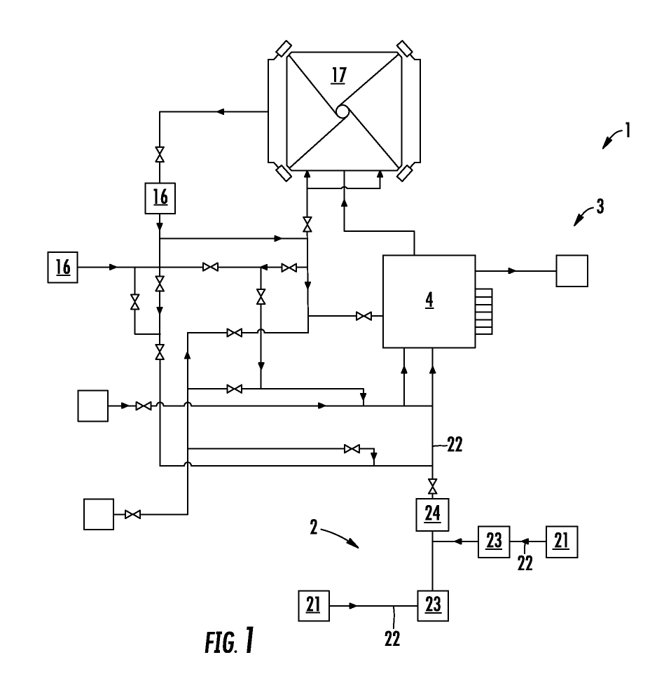

FIGS. 1-4 illustrate exemplary embodiments of systems that are configured to utilize input reactants, such as coal, lime, and oxygen or air to generate heat (that may be used to produce electric power) as well as useful by-products, such as CaC₂. The coal and lime (e.g., CaO) reactants may be fed into the system as large lumps or fine particles, which may pass through one or more grinding or crushing devices to reduce the size of the reactants. The pulverized reactants (e.g., coal or coke or C, and CaO) are then fed, along with air (or oxygen, or a combination thereof), into the reactor to undergo the carbothermic reduction of calcium oxide (CaO) to CaC₂, which takes place at temperatures above 1600° C.

As shown in FIG. 1, an exemplary embodiment of a system 1 includes an input assembly 2, an output assembly 3, and a reactor 4. The input assembly 2 is configured to introduce one or more reactants into the reactor 4, and the output assembly 3 is configured to recover one or more by-products from the reactor 4. The input assembly 2 may include one or more than one feeder 21 that is configured to introduce a reactant into the reactor 4, such as through a conveyor 22. The input assembly 2 may also include a pulverizing or crushing device 23 that is configured to reduce the particle size of the reactant(s) received from the feeder 21. Accordingly, the input assembly 2 may include a pulverizing device 23 arranged in series with a feeder 21 for each reactant that is input into the reactor 4. The reactant(s) may then be fed into the reactor directly from the pulverizing device 23, from an optional intermediate feeder 24, which may be configured to combine multiple reactants (e.g., reactants, co-reactants), or directly from the feeder 21.

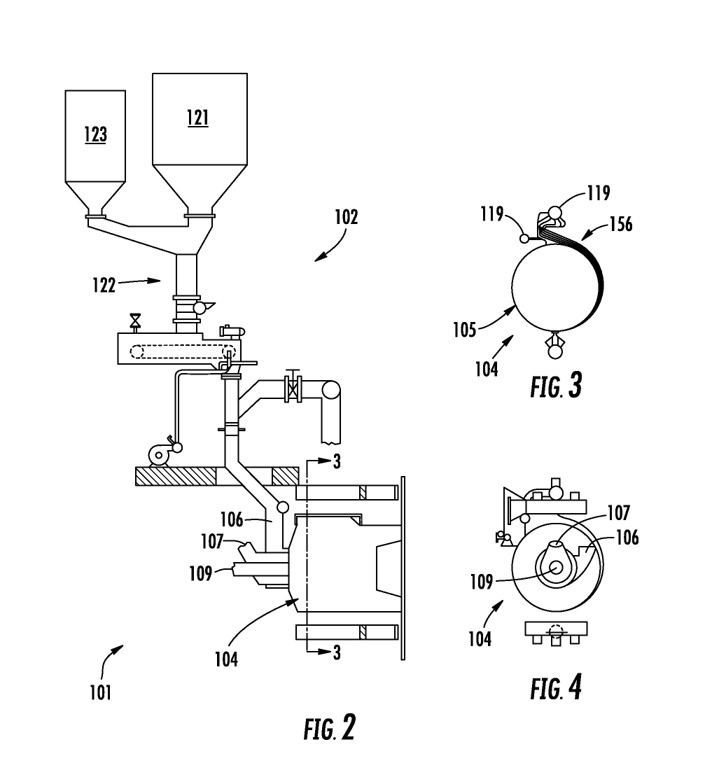

The system may further include additional devices or components as well, some of which are illustrated in FIGS. 1 and 2. For example, the system may further include a generator 15 for producing electric power from the heat generated by the reaction within the reactor, where the generator 15 may be configured in combination with a steam turbine. As another example, the system may include one or more than one fan assembly 16 for generating forces to induce the flow of air and/or oxygen, such as for providing a primary or secondary fluid (e.g., air, oxygen, a combination thereof) to the reactor to aid in the reaction therein. Furthermore, the downstream vessel or device 17 that generates the steam for the electric power process can be used for combustion of any remaining fuel components or carbon-monoxide (CO) due to an incomplete combustion, such as in a reactor where a small stoichiometric ratio (e.g., of about 1) may be necessary.

As shown in FIGS. 2-4, another exemplary embodiment of a system 101 includes an input assembly 102 and a reactor 104. The input assembly 102 includes two feeders 121 and 123, where each feeder 121, 123 is configured to introduce (e.g., input) a reactant (or reactants) into the reactor 4 through a conveyor 122. A first input reactant, such as coal, may be fed into the first feeder 121, and a second input reactant may be fed into the second feeder 121. The first and second reactants may be different or similar. For example, coal may be fed into the first feeder 121 and lime may be fed into the second feeder 123. As shown, the conveyor 122 is configured to utilize gravity to help feed the input reactants into the reactor 104. However, it should be noted that the conveyor 122 may utilize any suitable method, such as forced air, or combination of methods, such as gravity and forced air, to transfer the reactants from the input assembly 102 to the reactor 104. For example, a blower or fan assembly may provide forced air to aid in the transfer of the reactants to the reactor 104. As shown in FIG. 3, the system 101 may further include a temperature regulating device to control the operating temperature of the housing 105 of the reactor 104, as discussed in greater detail below.

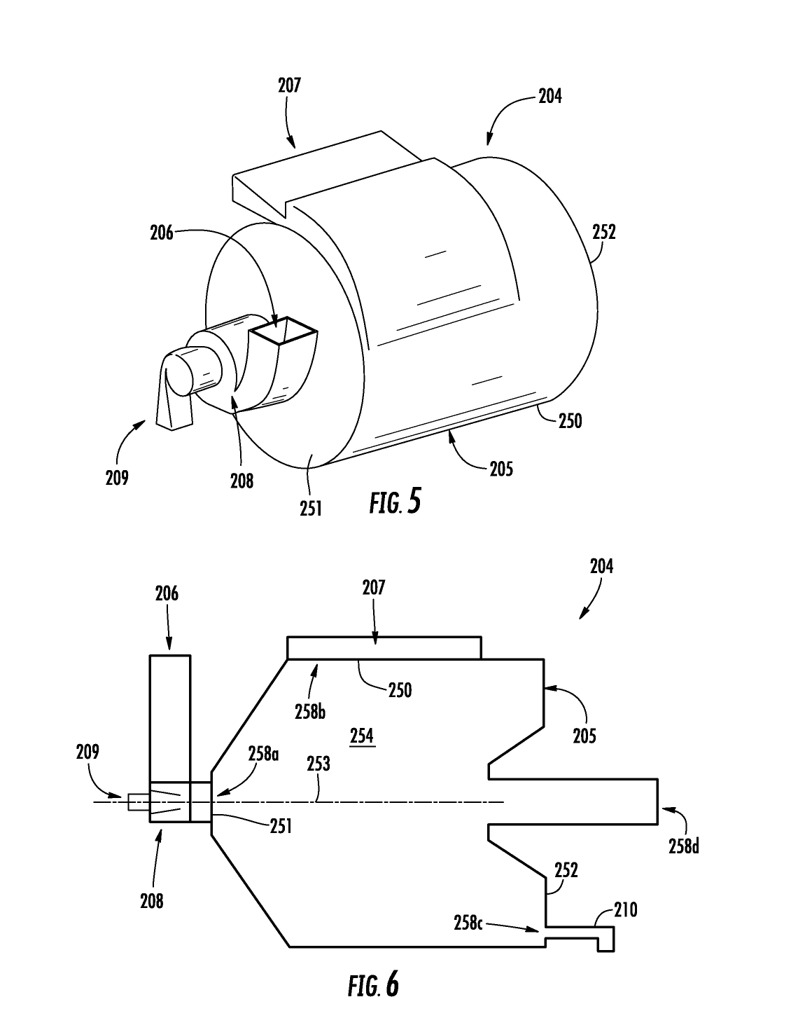

The reactor 104 may include several inlets configured to introduce a reactant or other material into the reactor 104. As shown in FIGS. 2 and 4, the reactor 104 includes a first inlet 106 configured to introduce a first reactant(s) (e.g., coal, lime), a second inlet 107 configured to introduce air, and a third inlet 109 configured to introduce recycled flue gas. However, it should be noted that the reactor may be configured differently.

FIGS. 5-10 illustrate another exemplary embodiment of a reactor 204 that is configured to generate heat and produce one or more by-products (e.g., CaC₂) generated from one or more than one input reactant. For example, the input reactant(s) may comprise calcium oxide (CaO), calcium carbonate (CaCO₃), coal, coke, lime, a combination thereof, or any other suitable material. Further, one or more than one co-reactant may also be used along with the one or more than one input reactant. For example, the co-reactant may comprise an oxide, hydroxide, carbonate (e.g., of calcium, lithium, sodium, potassium, magnesium, etc.), or any other suitable element or compound. As other examples, the reactant and/or co-reactant may comprise methane, a compound made from biomass or any renewable source, municipal solid waste, and/or any carbonaceous material.

The reactor 204 includes a substantially cylindrical housing 205 having a first end 251 (e.g., an input end) and a second end 252 (e.g., an output end), a first inlet 206 (e.g., a primary inlet), a second inlet 207 (e.g., a secondary inlet), and a burner 208. According to an exemplary embodiment, the first inlet 206 and the burner 208 are provided at the first end 251 of the reactor 204. The first inlet 206 is configured to be connected (e.g., coupled) to the burner 208, and is configured to supply the burner 208 with reactant(s) and/or co-reactants. The coupled first inlet 206 and burner 208 may be connected to the first end 251 of the housing 205, and the burner 208 may be aligned with a central longitudinal axis 253 of the housing 205. This arrangement may produce a flame zone that extends from the burner 208 through a central portion of the housing 205 along the central longitudinal axis 253. As shown, the second inlet 207 is configured to be connected to an outer wall 250 of the housing 205 between the first end 251 and the second end 252 of the housing 205. The second inlet 207 is configured to introduce reactants and/or co-reactants into the housing 205.

The housing 205 of the reactor 204 may be substantially cylindrically or barrel shaped having an outer wall 250 and a central longitudinal axis (e.g., mid axis) 253, where the outer wall 250 extends from a first end 251 to a second end 252. The housing 205 defines a chamber 254 (e.g., a combustion chamber) in which the gas staging conditions or operations are configured to occur therein. The first and second ends 251, 252 of the housing 205 may be configured to have any suitable shape. For example, the first end 251 may be cone-shaped.

The housing 205 may be configured to extend horizontally, and/or may be tapered (e.g., inwardly or outwardly from the first end to the second end). The housing 205 also may be configured at an inclination angle relative to horizontal with the lower end at the slag outlet (second end 252) to influence the slag flow. According to other embodiments, the housing may be arranged at an inclination angle with the lower end at the first end or may configured to extend in a vertical direction. Where the housing 205 has a tapered wall, an oblique wall, or is configured at an angle of inclination, the housing may influence flow velocity and/or residence time of the slag layer 213, such as by utilizing gravity. In addition, the housing 205 may be configured to be fixed, such as fixed on the central longitudinal axis 253, or may be configured to move. For example, the housing 205 may be configured to rotate about the central longitudinal axis 253. Also for example, the housing 205 may be configured to oscillate or vibrate, which may help influence the reactions in the housing, such as by influencing the flow of the slag layer 213 in the housing 205.

The outer wall 250 of the housing 205 may include one or more than one layer of material. For example, the outer wall 250 of the housing 205 may include an outer layer configured to provide strength and durability to the housing 205 and an inner layer configured to resist the extremely high temperatures (e.g., 1600-2500° C.) that occur within the reactor 204. The outer layer of the outer wall 250 of the housing 205 may be made from steel (or other suitable high strength material) and the inner layer of the wall 250 of the housing 205 may be made from a refractory material or metal, such as niobium (Nb), molybdenum (Mo), tantalum (Ta), tungsten (W), zirconium (Zr) or rhenium (Re), and/or alloys or combinations thereof that may advantageously exhibit relatively high temperature resistance. The inner refractory layer may also be made from other insulating materials, such as silicon or silicon based compound, or from ceramics (e.g., zirconium dioxide, aluminum oxide, magnesium oxide, yttrium oxide, silicon carbide, silicon nitride, boron nitride, mullite, aluminum titanate, tungsten carbide). The inner refractory layer may be configured as a cladding or lining covering the inner surface of the outer layer, may be formed as a separate tube and then provided within and adjacent to the outer layer, or may be configured in any suitable manner. It should be noted that the outer and inner layers may be made from other suitable materials or methods, and those materials and methods disclosed herein are not intended as limiting.

In addition to the refractory, the reactor 204 may also utilize the formation of the slag layer 213 as another way to shield the outer wall 250 of the housing 105 from the high temperatures in the reactor 204 during operation. As the deposition of slag forms along the inner surface of the outer wall 250, both an inner molten layer 213b (e.g., melt film layer) and an outer solidified layer 213a form, where a self-insulation effect may occur as a result of the solidified layer 213a. The solidified layer 213a may reduce the effective temperature close to the outer wall 250 relative to the high temperatures at the core of the reactor 204. This self-insulating effect may protect the material(s) that forms the outer wall 250.

The housing 205 may further include one or a plurality of tubes 256 that are configured to circumscribe at least a portion of the outer wall 250 of the housing 205. The tubes 256 may be configured to carry a fluid (e.g., water, oil, air) that may be used to regulate the temperature of the outer wall 250 during operation of the reactor 204, such as to cool the outer wall 250. According to an exemplary embodiment, a plurality of tubes 256 may be annular in shape to wrap around the circular shape of the housing. In this arrangement, the plurality of tubes 256 may have a side-by-side arrangement around the housing. According to another exemplary embodiment, a tube 256 may have a helical shape and may be configured to wrap and wind around the outer wall 150 of the housing 205. FIG. 7 is a cross-sectional view cut through the reactor 204, which could illustrate either the helical arrangement of the tube 256 or the plurality of annular tubes 256 having a side-by-side arrangement.

As shown in FIG. 7, the tube(s) 256 has (have) a semi-circular cross-section, wherein ends 256a of the semi-circular cross-section abut the outer wall 250 directly forming a cavity 257 (e.g., channel) between the tube 256 and the outer wall 250 for the fluid to pass through. Thus, the fluid may directly contact the outer surface of the outer wall 250 of the housing 205 to more efficiently regulate the temperature of the wall 250 of the housing 205.

The fluid may be directed into the tube(s) 256 from a temperature regulating device, such as a heat exchanger. Further, the fluid may exit the tube(s) 256 and pass back into the temperature regulating device to form a thermodynamic cycle. Thus, for example, the fluid may absorb heat from the outer wall 250 of the housing 205 as the fluid passes over the wall 250, conducting some of the heat to the wall of the respective tube 256. The heat in the wall may then be absorbed by a second fluid (e.g., air) passing over the respective tube 256 through convection, while the heat remaining in the first fluid may be absorbed by the temperature regulating device.

As shown in FIG. 3, the plurality of tubes 156 of the reactor 104 may extend around the housing 105 and also extend away from the housing 105 to a device 119 configured to regulate the temperature of the fluid passing through the plurality of tubes 156. Thus, the temperature regulating device 119 may be configured as part of the system 101 and disposed near to the reactor 104. The system 101 may include more than one temperature regulating devices 119.

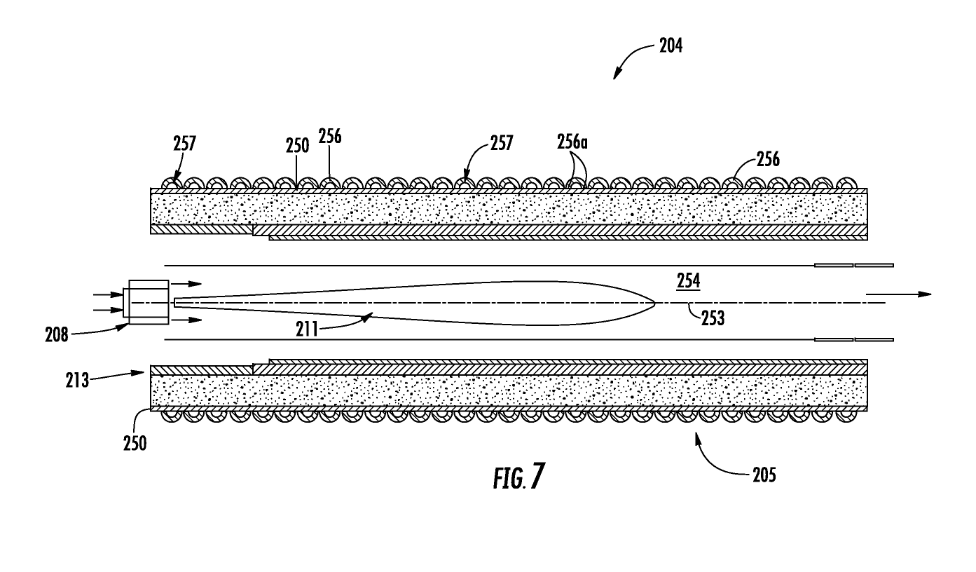

The housing 205 may include an opening 258 or a plurality of openings to introduce reactants (and co-reactants when used) and to remove usable by-products and other materials formed during operation. As shown in FIG. 6, the housing 205 includes two inlet openings in the form of a first inlet opening 258a and a second inlet opening 258b. The first inlet opening 258a is disposed in the first end 251 of the housing 205, and is configured to be in fluid communication with the burner 208 and/or the first inlet 206. In other words, the first inlet opening 258a of the housing 205 is configured so that the reactants passing through the first inlet 206 can be ignited by the burner 208 to produce a flame zone that extends through the first inlet opening 258a and along the central longitudinal axis 253. The second opening 258b is disposed in the outer wall 250 of the housing 205, and is configured to be in fluid communication with the reactants and/or co-reactants from the second inlet 207.

Also shown in FIG. 6, the housing 205 includes two outlet openings in the form of a first outlet opening 258c and a second outlet opening 258d. The first outlet opening 258c is configured to allow for the removal of the produced by-products (e.g., CaC₂) as part of the slag layer 213 from the reactor 204. The first outlet opening 258c may be disposed in the second end 252 along the bottom of the outer wall 250 of the housing 205 to help facilitate the recovery of the slag layer 213 and by-products, such as by allowing it to flow directly out through the first outlet opening 258c. The second outlet opening 258d is configured to allow off-gas (e.g., CO) formed by the reactions to be removed from the chamber 254 therethrough. The second outlet opening 258d may be centrally located in the second end 252 of the housing 205 or may be located anywhere along the housing 205. It should be noted that the first outlet opening 258c and the second outlet opening 258d may be combined into a single outlet opening that is configured to both allow for the removal (e.g., recovery) of the slag layer 213 and associated by-products as well as to provide for the release (e.g., escape) of the off-gas from the reaction.

According to an exemplary embodiment, the first inlet 206 is configured to convey or transfer the primary reactants (e.g., pulverized coal, pulverized lime, air, oxygen) to a location where the burner 208 is able to ignite the reactants in the combustion chamber of the housing 205. The first inlet 206 may be provide as a pipe or hollow tube member that defines a passageway for the reactants to flow therein, such as from an input assembly of the system. The first inlet 206 may extend in a substantially linear direction (e.g., vertical), a non-linear direction (e.g., arcuate), or any suitable direction that can transfer the reactants to the reactor 204 to facilitate the reaction in the housing 205.

The first inlet 206 may be formed of any suitable material that is strong and durable enough to allow for the repeated conveyance (or transfer) of material (e.g., reactants) through the inlet and into the reactor 204. The first inlet 206 may include a first end connected to the burner of the reactor 204 (or directly to the housing 205 adjacent to the burner), and a second end that is connected to a device (e.g., an input assembly) that feeds the primary reactants into the first inlet 206. The first inlet 206 may include a damper or other device configured to regulate or adjustably control the flow rate of the reactants into the housing 205. Thus, the first inlet 206 may introduce the primary reactants into the burner at a controlled (and adjustable) flow rate to fuel the reaction within the reactor 204 in a controlled manner. The first inlet 206 may be configured to have an adjustable pressure to produce an adjustable velocity that pushes the reactants through the inlet and into the reactor 204.

The burner 208 may be cylindrically shaped and configured to connect to the first end 251 of the housing 205, such that the burner 208 is aligned substantially with the central longitudinal axis 253 of the housing 205 and reactor 204. The burner 208 is configured to produce a flame zone 211 for the purpose of combustion of a first portion of the reactants (e.g., the primary reactants) in an exothermic reaction within the reactor 204. As shown in FIG. 7, the flame zone 211 produced by the burner 208 is configured to extend from the burner 208 through combustion chamber 254 within the housing 205 along the central longitudinal axis 253. In other words, the burner 208 may be configured to facilitate the combustion of a first portion of the reactants in an exothermic reaction near the center of the chamber 254. The burner 208 may include any now known or future developed device for producing the flame to combust the reactants in the flame zone 211. The burner 208 may receive the primary reactants from the first inlet 206 and redirect the primary reactants to produce the flame zone 211 that extends from the first end 251 of the housing 205 toward the second end 252 along the central longitudinal axis 253 of the housing 205.

According to an exemplary embodiment, the second inlet 207 is configured to introduce (e.g., convey, transfer, etc.) a fluid (e.g., secondary air, oxygen) into the reactor 204 from a source, such as an input assembly. In other words, the second inlet 207 may introduce one or more additional (or secondary) reactants into the reactor 204. The second inlet 207 may be provided as a pipe or hollow tube member that defines a passageway for the fluid to flow therein.

The second inlet 207 may connect to the outer wall 250 of the housing 205 between the first and second ends of the housing 205, or may be configured to connect anywhere on the housing 205. As shown in FIGS. 5 and 6, the second inlet 207 is configured to introduce the fluid comprising a secondary air in a tangential direction relative to the direction of the flame zone 211 (i.e., region where combustion of the primary reactants occurs) and/or the central longitudinal axis 253 in order to generate swirl within the reactor 204. The swirl caused by the fluid from the second inlet 207 induces forces (e.g., centrifugal forces) that distribute the reactants (e.g., carbon and CaO) to the outer wall 250 of the housing 205, where the distributed reactants react in the reducing atmosphere to form the slag layer 213 and produce the by-product (e.g., CaC₂). The second inlet 207 may include a damper or other device configured to regulate or adjustably control the flow rate of the fluid (or reactants) that pass into the housing 205 through the second inlet 207. In addition, the second inlet 207 may introduce air into the reactor 204 that has a temperature that is different than the temperature of the primary air introduced through the first inlet 206. For example, the temperature of the secondary air may be elevated to a temperature between approximately 100-1100° C.

The oxygen supply of the second inlet 207 or gas feed may be tightly controlled to prevent consumption of the carbon prior to generation of the carbide reaction. If not tightly controlled, under the conditions for the carbide reaction, the carbon may burn to carbon monoxide, such that the carbon for the carbide reaction may be consumed before initiation of the carbide generation. Thus, there may be some over-stoichiometric amount of carbon in the deposition zone or in the reactants introduced through the second inlet 207 so that some carbon monoxide can be produced. The carbon monoxide by the incomplete combustion, as well by the carbide reaction, can then burn completely or at least partially to carbon dioxide when mixed with oxygen in the inner or central region of the reactor 204, such as in the exothermic reaction region.

To further control and/or influence the complex demand and reaction conditions in the reactor 204, a third inlet (e.g., supply) may be provided. As shown in FIGS. 5 and 6, the reactor 204 includes a third inlet 209 (e.g., a tertiary inlet) that is provided adjacent to the first end 251 of the reactor 204 and is configured to introduce a fluid (e.g., a second fluid) into the burner 208 to help facilitate the combustion of the reactants along the flame zone 211. The third inlet 209 may be provided as a pipe or hollow tube member that is configured to introduce a second fluid (e.g., air, oxygen) at an adjustable velocity to aid in the combustion of the reactants within the flame zone 211. The third inlet 209 may be configured to inject the second fluid in a direction substantially along the central longitudinal axis 253 of the housing 205 or may be configured to inject the fluid in a direction at an oblique angle relative to the central longitudinal axis 253 to induce swirl within the reactor 204. The third inlet 209 (or additional inlets) may include a damper or other device configured to regulate or adjustably control the flow rate of the fluid (or reactants) that pass into the housing 205 through the inlet. It should be noted that the reactors disclosed herein (e.g., the reactor 204) may include any number of inlets configured to influence or tailor the flow of the reactants. For example, additional inlets may be configured along the wall of the housing 205 of the reactor 204 for improving swirl, and the inlets disclosed herein are not intended as limiting.

The reactor 204 may further include an outlet 210 (e.g., a slag outlet) configured to facilitate the removal of the slag material or the slag layer 213 along with one or more than one by-product (e.g., CaC₂) from the reactor 204, such as from the housing 205. As shown in FIG. 6, the outlet 210 is aligned with and adjacent to the first outlet opening 258c in the second end 252 of the housing 205. The outlet 210 may be provided proximate the bottom of the outer wall 250 of the reactor 204 to allow for easier recovery of the slag layer 213 (e.g., liquid slag layer) that forms on the inside surface of the outer wall 250 of the housing 205 of the reactor 204 during operation (e.g., gas staging operation). The outlet 210 may comprise a tap or valve that allows for selective and adjustable recovery of the slag layer 213 including the desired by-products. The outlet 210 may be configured to allow for inert handling of the slag layer 213 and/or cooling of the slag material until solidification, such as without obstructing the flow through the outlet 210. For example, a liquid (e.g., oil, liquefied nitrogen) quench may be incorporated into the outlet 210 or subsequent to removal of the slag layer 213 through the outlet 210 to accelerate cooling and solidification of the slag material.

The fluid (e.g., primary, secondary, tertiary) used in the inlets (e.g., first, second, third) may be air, oxygen, or a combination thereof, or may include recycled flue gas from the reactor 204, such as a CO-rich fraction of flue gas that would aid in creating the reducing atmosphere needed for carbide-generation reaction along the outer wall 250 of the housing 205 of the reactor 204. For example, recycled flue gas may be cooled, compressed, then reheated prior to reintroduction into the reactor 204. Also, the recycle flue gas may be extracted from the reactor 204 through an additional gas-outlet, such as the second outlet opening 258d in the housing 205. Alternatively, the additional gas-outlet may be configured close to the outer wall 250 of the housing 205 or may be configured anywhere on the housing 205. Furthermore, the second inlet 207 and/or third inlet 209 may be used to feed a fraction of the reactants (e.g., CaO, C, coal) to influence the location and the homogeneity of the particle deposition, or the rate of deposition, along the outer wall 250 of the housing 205. Computer simulation (e.g., CFD analysis) suggests that if deposition occurs too early in the process, then the deposition rate at the downstream section of the reactor 204 may be reduced. In the extreme case, a reduced deposition may leave a portion of the reactor 204 uncovered by slag, which may prove detrimental to the wall refractory over time by reducing the durability (e.g., longevity) of the uncovered refractory. The deposition rate downstream may also be influenced by the third inlet 209. For example, the third inlet 209 may be configured to support or provide tangential distribution and/or the axial transport of the deposition layer to promote downstream deposition along the outer wall 250.

The primary reactants (e.g., air, oxygen, pulverized coal, and pulverized lime) are transferred at a controlled flow rate through the first inlet 206 into the reactor 204 where the burner 208 initiates combustion of some of the primary reactants creating a flame zone 211 that passes through the center region of the hollow reactor 204, such as along the central longitudinal axis 253 of the housing 205. A first portion (e.g., some of the particles) of the reactant (e.g., carbon from the coal) reacts with oxygen in the oxidative atmosphere of the flame zone 211 in an exothermic reaction that generates very high temperatures as well as by-products such as carbon monoxide and carbon dioxide. The fluid and/or second fluid (e.g., air, oxygen, recycled flue gas, combination thereof) enters the reactor 204, such as along the outer wall 250 in a direction substantially tangential to the flame zone 211 of combusting reactants, with a velocity that induces swirl within the reactor 204 thereby creating centrifugal forces that distribute the particles of carbon and CaO along the inside surface of the outer wall 250 of the housing 205 of the reactor 204. A second portion (e.g., some of the particles) of the reactant (e.g., carbon and CaO) that deposit along the outer wall 250 reacts in the reducing atmosphere, such as in the slag layer 213, in an endothermic reaction that produces a usable by-product (e.g., CaC₂). The tangential velocities created by the fluid from the second inlet 207 and the axial velocities created by the flame zone 211 (e.g., primary air, tertiary air) and/or the second fluid from the third inlet 209, combined with gravitational forces, enable the liquid slag layer to flow along the inside surface of the outer wall 250 of the reactor 204. The slag layer 213 (e.g., liquid slag layer) including the usable by-product (e.g., CaC₂) then may be removed, such as through the outlet 210 of the reactor 204 to be processed to recover the useable by-product (e.g., CaC₂) from the slag material.

The feed of auxiliary material into the reactor 204 may be necessary to influence or control the slag melting temperature. Melting temperatures that are too high may inhibit the formation of the liquid slag layer, while melting temperatures that are too low may inhibit the reaction that produces the carbide generation as well as may allow for the formation of a liquid layer that is too thin, which induces high liquid velocities and low residence time. The melting temperatures of CaO and CaC₂ are relatively high (e.g., about 2600° C. and about 2300° C. respectively). Thus, a eutectic mixture of both CaO and CaC₂ having a mass ratio of about 1:1 is preferable, since it may supply a minimum melt temperature of about 1810° C., which is in the desired temperature range (e.g., 1600-2500° C.).

As shown in FIGS. 7-10, the reactor 204 is configured to induce the formation of a slag layer 213 along the inside surface of the outer wall 250 of the housing 205 from the deposited reactants. The slag layer 213 may include several layers. The slag layer 213 may include a solidified melt layer 213a that cools partially from contacting the temperature regulated outer wall 250 of the reactor 204. The solidified melt layer 213a that abuts the inner surface of the outer wall 250 of the housing 205 of the reactor 204 may form from the solidified slag after start-up of the reactor 204. The solidified melt layer 213a aids in protecting the outer wall 250 of the housing 205, since the high temperatures generated in the reactor 204 may be high enough to damage the refractory layer of the wall 250. The reactor 204 may be configured, such as by the position and orientation of the inlets or by the inclination of the reactor 204, to induce swirl in order to ensure slag deposits along the entire inner surface of the outer wall 250 of the housing 205, or to cool portions of the wall 250 to ensure stability in the high temperatures. The solidified melt layer 213a may have no velocity, and may help to insulate the outer wall 250 of the housing 205 of the reactor 204 from the very high temperatures that exist in the center region or oxidizing atmosphere region of the reactor 204. The slag layer 213 may include a melt film layer 213b provided adjacent to the solidified melt layer 213a that includes the reducing atmosphere for producing the CaC₂. The melt film layer 213b may be liquid and may have a velocity (that may be induced by velocities within the reactor 204) that pushes the liquid slag toward the second end 252 of the housing 205 of the reactor 204 to enable recovery of the usable by-product (CaC₂) through the outlet 210. The slag layer 213 may also include a solid reactants layer 213c provided between the liquid melt film layer 213b of the slag layer 213 and the chamber 254.

The formation of the slag layer 213 may be influenced or tailored, such as through the introduction of materials (e.g., additives) that effect the characteristics (e.g., melt, flow, etc.) of the slag layer. For example, melt promoting additives may be introduced into the reactor 204 to promote the formation of the slag layer 213 in the reactor 204 during its operation so that the carbothermic reaction can be carried out at lower temperatures in a melt. As another example, the additives may serve as fluxants configured to lower the melting of ash and lower the temperature at which dissolution of the CaO occurs in the melt. The fluxant additives may be configured to promote the flow of the melt, such as by influencing (e.g., decreasing) the viscosity of the slag layer 213, such as the liquid melt film layer 213b, to allow the carbon to move more freely in the liquid layer, which may speed up the reaction between the carbon and the CaO to promote the production of the CaC₂. As another example, catalytic additives may be introduced into the reactor 204 to accelerate the formation of the by-product (e.g., CaC₂) in the melt as part of the slag layer 213. The presence of CaC₂ in the slag layer 213, such as in the liquid melt film layer 213b, may serve to promote the chemical reaction that forms additional compounds of CaC₂. In this case, the input reactant being fed into the reactor 204 may be doped with CaC₂ in order to serve as a catalyst in the formation of CaC₂ in the slag layer 213 near the outer wall 250 of the housing 205 during the endothermic reaction. The initial presence of CaC₂ in the reactor 204 may also form a eutectic mixture thereby lowering the melt temperature to promote the formation of CaC₂. The additives (e.g., melt promoting, fluxants, catalysts) may be fed into the reactor, such as through an inlet (e.g., first, second, third) of the reactor as reactants or co-reactants. The additives may comprise minerals, elements, or any suitable compound (e.g., silica, alumina). Examples of catalytic additives may comprise a carbide (e.g., CaC₂), an oxide (e.g., manganese oxide), and/or certain metals (e.g., copper). Examples of promoting additives may comprise, among others, non-volatile alkali and alkaline earth metal oxides, hydroxides, and/or carbonates (e.g., potassium, sodium, strontium, barium).

FIG. 11 illustrates another exemplary embodiment of a reactor configured to receive reactants (e.g., coal and lime) for generating heat and producing a by-product (e.g., CaC₂) through reactions within the reactor. As shown, the overall diameter A of the housing 305 of the reactor 304 is about 140.97 cm (55.5 inches), the diameter B of the housing is about 52.07 cm (20.5 inches), the diameter C of the second outlet 358d of the housing 305 is about 71.44 cm (28.125 inches), the diameter D of the housing 305 is about 90.17 cm (35.5 inches), the length E of the outer wall 350 is about 214.63 cm (84.5 inches), the length F of the housing 305 is about 19.05 cm (7.5 inches), the length G of the housing 305 is about 40.32 cm (15.875 inches), the length H of the second inlet 307 is about 111.13 cm (43.75 inches), the height I of the second inlet 307 is about 16.19 cm (6.375 inches), the length J is about 38.1 cm (15 inches), the length K is about 21.59 cm (8.5 inches), the length L is about 27.94 cm (11 inches), the diameter M is about 22.23 cm (8.75 inches), and the diameter N is about 45.09 cm (17.75 inches). The dimensions provided for the different features of the reactor 304 are for an exemplary embodiment, and it should be noted that this embodiment is merely an example of one reactor and the dimensions are not meant as limitations to the construction of other embodiments of reactors as disclosed herein. Further, the dimensional configuration of the reactor may be tailored to accommodate different parameters. For example, different dimensional reactors may be constructed to accommodate different size systems (e.g., coal furnace systems or burner 208 types). For example, the aspect ratio of the reactor length to the reactor diameter may be increased to allow for a longer centerline flame zone as well as enough residence time for the reactants to achieve the high temperatures along the wall of housing to allow substantially all of the reactants to convert into the usable by-product (e.g., CaC₂).

The reactor 304 of FIG. 11 was simulated using computer modeling and evaluated using computational fluid dynamic (CFD) computer software as a predictive tool to the outcome of such a reactor. Note that this analysis was not performed on a working model, but rather through a computer simulated model. Table 1 (provided below) lists the parameters (and respective value for each parameter) that were input into the computer simulation software to evaluate Example 1 using CFD analysis.

TABLE 1
Input Parameters for CFD Model of Example 1

| Parameter [units] | value |
|---|---|
| Barrel Firing Rate [MBtu/hr) | 92.0 |
| Crushed Coal Flow Rate [kg/hr] | 4416 |
| Barrel Flue Gas @ 100% Burnout [kg/hr] | 26163 |
| Combustion Air + O₂ Flow Rate [kg/hr] | 22438 |
| Barrel Primary Air Mass Flow Rate [kg/hr] | 5038 |
| Barrel Primary Air Temperature [° C.] | 100 |
| Barrel Secondary Air Mass Flow Rate [kg/hr] | 15113 |
| Barrel Secondary Air O₂ Mass Flow Rate [kg/hr] | 1227 |
| Barrel Secondary Air Temperature [° C.] | 400 |
| Barrel Tertiary Air Mass Flow Rate [kg/hr] | 1060 |
| Barrel Tertiary Air Temperature [° C.] | 400 |
| Combustion Air O₂ Content [Vol. Fraction] | 0.2076 |
| Combustion Air N₂ Content [Vol. Fraction] | 0.7809 |
| Combustion Air H₂O Content [Vol. Fraction] | 0.0115 |
| Barrel Coal and Air Stoichiometric Ratio [1] | 0.85 |
| Barrel Adiabatic Flame Temperature [K] | 2481 |
| CaO Mass Flow Rate [kg/hr] | 771 |

For the CFD model of Example 1 of the reactor 304, coal, calcium oxide (CaO), and primary combustion air enter the first inlet opening 358a of the housing 305 from the first inlet 306 at a location that is adjacent the scroll burner 308 at the first end 351 of the housing 305. A fluid comprising secondary air enters the housing 305 through the tangentially configured second inlet 307 adjacent the outer wall 350 of the housing 305. A second fluid comprising tertiary air enters the housing 305 through first inlet opening 358a along the central longitudinal axis 353. During the computational analysis run of the reactor 304, a first portion of the coal particles is combusted while moving in suspension in the flame zone along the central longitudinal axis 353, and a second portion of the coal particles becomes deposited on the inside surface of the outer wall 350 together with CaO due in part to the centrifugal acceleration induced by the swirling motion in the reactor 304. The reactor 304 is equipped with a studded (cooled) wall section close to the second inlet 307, and the remainder of the wall 350 is refractory lined.

It should be noted that this CFD model takes into consideration only coal combustion and was modeled to mainly establish reaction conditions appropriate for calcium carbide (CaC₂) generation as part of the slag layer along the outer wall of the housing. The complex fluid dynamics, mass transfer and reaction phenomena governing carbide generation in the slag layer was not captured by the CFD model and therefore was considered separately in a separate example (multi-scale modeling approach) discussed below. Accordingly, the main output of the CFD model of Example 1 was the wall temperature distribution which serves as an input for the film calculations used in the one-dimensional model of Example 2. The results (i.e., the output) of the CFD model of Example 1 are provided in Table 2 below.

TABLE 2
Output of CFD Model of Example 1

| Parameter [units] | value |
|---|---|
| Reactor Exit Flue Gas Temperature [K] | 2310 |
| Reactor Exit Flue Gas CO Content [ppm, wet] | 88691 |
| Reactor Exit Flue Gas O₂ Content [Vol. %, wet] | 0.75 |
| Coal Burnout [Wt. %] | 99.9 |
| Fraction Coal Ash Escape [Wt. %] | 11.7 |
| Fraction Organic Escape [Wt. %] | 0.1 |
| CaO Fraction Escape [Wt. %] | 5.0 |
| Heat Transfer to Cooled Studs [MW] | 0.475 |

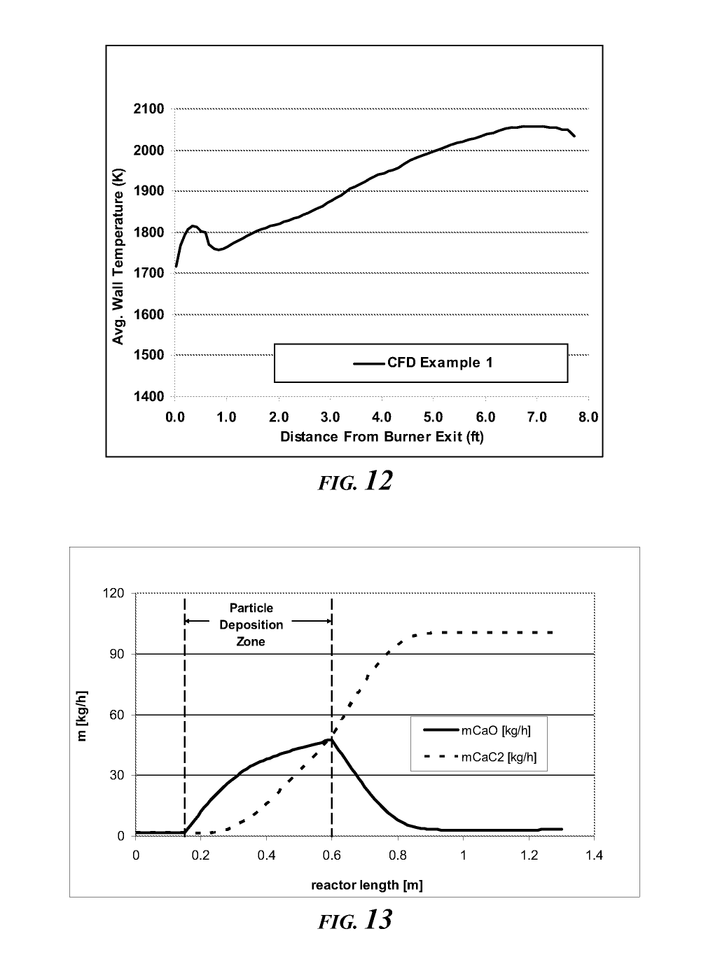

To assess the calcium carbide generation as part of the slag layer along the outer wall, the local wall temperature distribution over the reactor length was evaluated in the CFD model of Example 1. FIG. 12 illustrates the results of the average wall temperature along the reactor axis for the CFD model of Example 1, which were then used in the one-dimensional model of Example 2 of the reactor 304, as discussed below. As shown in FIG. 12, the CFD model of Example 1 predicted an average wall temperature along the reactor in excess of 1600° C. A temperature in excess of 1600° C. is believed to produce calcium carbide (CaC₂). Therefore, based on the computational modeling, it is believed that the conditions for producing CaC₂ from the reaction of coal, calcium oxide (CaO), and air would be present in the combustion chamber of a reactor constructed in accordance as disclosed herein that is configured to utilize the gas staging process. Further, the CFD model of Example 1 also predicted a CO content (i.e., concentration) that exceeds 150,000 ppm along the outer wall and a CO content that is nearly zero ppm along the central axis of the modeled reactor. Accordingly, the oxidizing conditions along the central axis of the reactor that facilitate the exothermic reaction are present and the reducing conditions along the outer wall of the reactor that facilitate the endothermic reaction are present in the CFD model of Example 1. Thus, the gas staging that is desired for producing the usable by-product of CaC₂ is achieved in the CFD model of Example 1, as the model predicts a full conversion (e.g., oxidation) of carbon to CO₂ along the axis.

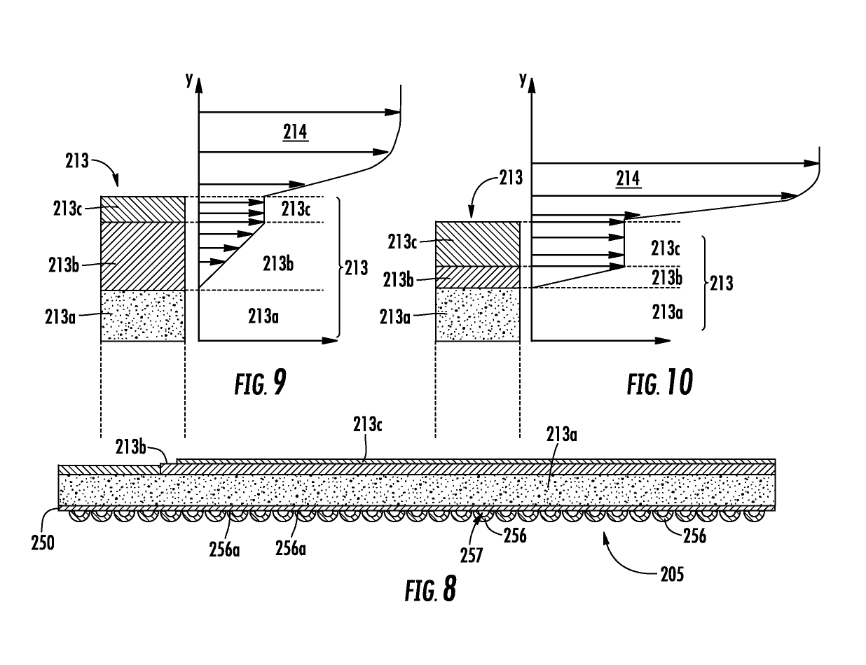

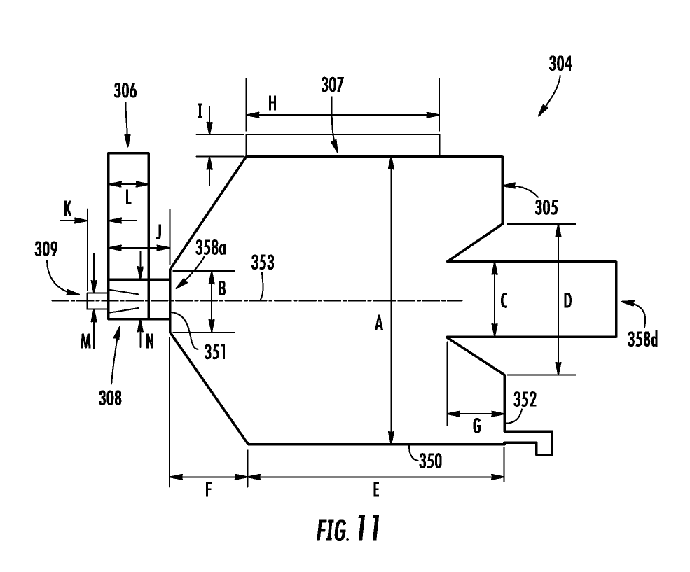

The one-dimensional model of Example 2 was performed to evaluate the predicted results pertaining to the fluid dynamics, heat transfer, mass transfer, and reaction kinetics in the reactor for generating the CaC₂ in the slag layer. To simplify the modeling, the reactor shown in FIGS. 8-10 was evaluated in the one-dimensional reaction model of Example 2. FIG. 9 illustrates the gas 214 and slag layer 213 flow profiles close to the reactor inlet (e.g., the first end), where coal combustion is not yet complete. Therefore, the gas 214 velocity is relatively low and the maximum liquid melt film (or molten slag) 213b velocity is also correspondingly low. In the model, the wall layer is composed of solidified slag 213a on the refractory, molten slag 213b, and pre-molten solid reactants 213c (e.g., coal and CaO particles) floating on top of the molten slag 213b. FIG. 10 illustrates the gas 214 and slag layer 213 flow profiles toward the reactor outlet (e.g., the second end) where coal combustion is almost complete. Therefore, the gas 214 velocity is relatively high and the maximum liquid melt film (or molten slag) 213b velocity is correspondingly high. The solid reactants 213c floating on top of the molten slag 213b are assumed to move with the maximum molten slag 213b velocity in the molten slag layer itself. The velocity of the molten slag 213b is shown to decrease linearly as the outer wall 250 is approached. Further, the particle deposition is assumed to take place over a given length of the reactor 204 close to the inlet or first end. It is assumed that the CaC₂ generation reaction takes place in the solid phase 213c floating on top of the molten slag 213b. In the model, some CaC₂ was added at the reactor inlet to reduce mixture melting temperature, such as to produce a eutectic effect between CaO and CaC₂. Table 3 (provided below) lists the parameters and assumptions (along with a respective value for each parameter or assumption) that were input into the computer simulation software to evaluate Example 2 using one-dimensional reaction modeling.

TABLE 3
Input Parameters for One-Dimensional Model of Example 2

| Parameter [units] | value |
|---|---|
| Film Coal Mass Flow Rate @ Reactor Inlet [kg/hr] | 60 |
| Film Calcium Oxide Mass Flow Rate @ Reactor Inlet [kg/hr] | 90 |
| Film Calcium Carbide Mass Flow Rate @ Reactor Inlet [kg/hr] | 1.68 |
| Flame Temperature on Reactor Axis [° C.] | 2230 |
| Reactor Inner Diameter [m] | 0.55 |
| Reactor Length [m] | 1.3 |

FIG. 13 illustrates the computer predicted conversion of the CaO to CaC₂ in the slag layer along the length of the outer wall of the reactor. As mentioned, some CaC₂ was introduced through the inlet of the reactor and CaO is introduced through the inlet over a length of the reactor that corresponds to the particle deposition zone. The computer model predicts that CaC₂ generation takes place upon addition of the CaO and achievement of a sufficiently high temperature. The computer model also predicts that after about 1 m (39.37 inches) an equilibrium condition in the reactor is reached where almost 97% of the CaO has been converted into CaC₂.

It should also be noted that the reactor may be configured to produce other useful by-products instead of or in addition to calcium carbide (CaC₂), including, but not necessarily limited to other carbides formed from the elements of groups one and two in the periodic table, such as lithium carbide (Li₂C₂), sodium carbide (Na₂C₂), potassium carbide (K₂C₂), and magnesium carbide (Mg₂C₃ or MgC₂). For example, the reactor may be configured to produce sodium carbide (Na₂C₂) and carbon monoxide from sodium oxide (or sodium carbonate) and carbon. Sodium carbide can be reacted with water to produce acetylene and sodium hydroxide. It is also believed that other acetylides may be formed within the reactor from the transition metal elements (e.g., group 11 of the periodic table), from the metal elements (e.g., group 12 of the periodic table), from lanthanoids (e.g., lanthanum (La), cerium (Ce), praseodymium (Pr), terbium (Tb)), steel, metallic silicon, aluminum, or other carbides. For example, copper carbide (Cu₂C₂) or zinc carbide (ZnC₂) may be able to be formed from within the reactor. Also, the reactor may be fed with bio-derived carbonaceous materials, such as biomass, biocoal, biochar, or a combination thereof, to produce bio-derived chemicals, such as bio-derived carbides. According to other exemplary embodiments, the systems and techniques discussed herein may be used to facilitate other reduction reactions, such as the reduction of iron oxides to elemental iron.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the reactors as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. A cyclone reactor for producing a usable by-product as part of a recoverable slag layer, the reactor comprising:
a housing having an outer wall that defines a combustion chamber;
an inlet configured to introduce a reactant into the reactor;
a burner configured to combust the reactant in a flame zone near a central axis of the chamber; and
an outlet configured to provide for the removal of the usable by-product from the housing;
wherein the reactor is configured to combust a first portion of the reactant in an exothermic reaction in the flame zone; and
wherein the reactor is configured to convert a second portion of the reactant in an endothermic reaction near the outer wall to produce the by-product as part of the slag layer.

2. The cyclone reactor of claim 1, further comprising a second inlet configured to introduce a fluid into the chamber to promote a reducing atmosphere near the outer wall of the housing to influence the endothermic reaction.

3. The cyclone reactor of claim 2, wherein the second inlet introduces the fluid in a tangential direction relative to a direction of the flame zone to generate swirl in the chamber.

4. The cyclone reactor of claim 3, wherein the fluid includes oxygen.

5. The cyclone reactor of claim 1, wherein the housing has a substantially cylindrical shape, and the burner is provided near a longitudinal axis of the housing so that the flame zone extends substantially along the longitudinal axis.

6. The cyclone reactor of claim 5, wherein the reactor is positioned such that the central longitudinal axis of the housing is substantially horizontal.

7. The cyclone reactor of claim 1, wherein the reactor is configured for gas staging such that the first portion of the reactant is combusted in an oxidizing atmosphere that is separated from the reducing atmosphere in which the second portion of the reactant is consumed.

8. The cyclone reactor of claim 1, wherein the reactant includes carbon.

9. The cyclone reactor of claim 1, wherein the by-product is a carbide.

10. The cyclone reactor of claim 9, wherein the by-product is selected from the group consisting of calcium carbide, lithium carbide, sodium carbide, potassium carbide, rubidium carbide, caesium carbide, francium carbide, beryllium carbide, strontium carbide, magnesium carbide, barium carbide, and radium carbide.

11. The cyclone reactor of claim 1, wherein the by-product comprises an acetylide.

12. The cyclone reactor of claim 1, wherein the by-product comprises a lanthanoid.

13. The cyclone reactor of claim 1, wherein the endothermic reaction takes place at a temperature of at least 1600° C.

14. The cyclone reactor of claim 1, wherein the outer wall of the housing comprises a refractory material.

15. The cyclone reactor of claim 1, further comprising a tube configured to carry a fluid therein to regulate the temperature of the outer wall.

16. The cyclone reactor of claim 2, further comprising a third inlet configured to introduce a second fluid at an adjustable velocity into the flame zone.

17. The cyclone reactor of claim 1, wherein the slag layer comprises a liquid layer.

18. The cyclone reactor of claim 17, wherein the slag layer further comprises a solid layer disposed adjacent the liquid layer.

19. The cyclone reactor of claim 1, further comprising a second outlet configured to vent the off-gas produced in the chamber outside the chamber.

20. The cyclone reactor of claim 1, wherein the slag layer includes at least one of a promoting additive, a fluxant additive, and a catalytic additive.

21. A method for producing a usable by-product in a cyclone reactor, the method comprising:
introducing a reactant into a housing of the reactor through an inlet;
using a burner to combust a first portion of the reactant in an exothermic reaction provided in a flame zone near a center of the housing;
consuming a second portion of the reactant in an endothermic reaction near an outer wall of the housing to produce the by-product as part of a slag layer; and
removing the slag layer including the by-product though an outlet in the housing;
wherein the endothermic reaction takes place at a temperature of at least 1600° C.

22. The method of claim 21, further comprising introducing a fluid into the housing through a second inlet to promote a reducing atmosphere near the outer wall of the housing to influence the endothermic reaction.

23. The method of claim 22, wherein the second inlet introduces the fluid in a tangential direction relative to the direction of the flame zone to generate swirl in the housing.

24. The method of claim 22, further comprising introducing a second fluid at an adjustable velocity substantially into the flame zone through a third inlet.

25. The method of claim 21, further comprising regulating the temperature of the outer wall of the housing through fluid carried within a tube.

26. The method of claim 21, wherein the by-product is a carbide.

27. The method of claim 26, wherein the by-product is selected from a group consisting of calcium carbide, lithium carbide, sodium carbide, potassium carbide, rubidium carbide, caesium carbide, francium carbide, beryllium carbide, strontium carbide, magnesium carbide, barium carbide, and radium carbide.

28. The method of claim 21, wherein the by-product comprises one of an acetylide and a lanthanoid.

29. The method of claim 21, wherein the slag layer comprises a liquid layer.

30. The method of claim 29, wherein the slag layer further comprises a solid layer disposed adjacent the liquid layer.

31. The method of claim 20, wherein the slag layer includes one of a promoting additive, a fluxant additive, and a catalytic additive.

32. The method of claim 20, wherein the reactor includes gas staging where the first portion of the reactant is combusted in an oxidizing atmosphere that is separated from the reducing atmosphere, in which the second portion of the reactant is consumed.

33. The method of claim 22, wherein the fluid promotes a higher temperature in the reducing atmosphere.
